(19) United States
(12) Patent Application Publication
(10) Pub. No.: US 2020/0119919 A1
(43) Pub. Date: Apr. 16, 2020

(54) ELECTRONIC DEVICE AUTHENTICATION MANAGING APPARATUS

(71) Applicant: CIOT CO., LTD, Busan (KR)

(72) Inventors: Hyeon Ju PARK, Yongin-si (KR); Han Na PARK, Incheon (KR)

(73) Assignee: CIOT Co., Ltd., Busan (KR)

(21) Appl. No.: 16/470,347

(22) PCT Filed: Mar. 28, 2017
(86) PCT No.: PCT/KR2017/003362

§ 371 Date: Jul. 22, 2019

(30) Foreign Application Priority Data
Dec. 16, 2016 (KR) 10-2016-0172743

(51) Int. Cl. H04L 9/32; H04L 29/06; H04W 12/08; H04W 4/80; H04L 29/08

(52) U.S. Cl. CPC H04L 9/32; H04L 63/08; H04L 67/12; H04W 4/80; H04W 12/08

(57) ABSTRACT

The present invention relates to a method for authenticating an electronic device using a simplified authentication code. The electronic device authentication managing apparatus includes: a communication unit communicating with an electronic device authentication server apparatus and an electronic device; a control unit comprehensively controlling the electronic device authentication managing apparatus; an authentication code request signal encryption unit encrypting an authentication code request signal; an encrypted authentication code request signal transmission unit transmitting the encrypted authentication code request signal; an encrypted signed authentication code reception unit receiving an encrypted signed authentication code from the electronic device authentication server apparatus; an encrypted signed authentication code decryption unit decrypting the encrypted signed authentication code; and an authentication code storage request signal transmission unit transmitting an authentication code storage request signal to the electronic device, wherein the electronic device authentication managing apparatus is connected to the electronic device through a GPIO interface.

### BACKGROUND OF THE INVENTION

### 1. Field of the Invention

The present invention relates to a technique of authenticating an electronic device, and more specifically, to a method of authenticating an electronic device using a simplified authentication code.

### 2. Description of Related Art

With all the numerous advances in security, hacking frequently occurs in the field of information communication technique. Therefore, frameworks for security of Internet of Things (IoT) for distinguishing several devices need to be proposed.

In the IoT field, people, apparatuses, services and contents are interconnected through networks. In this process, access control to IoT devices through identity confirmation, authentication and integrated management of all IoTs is needed. Authentication of a device based on a Public Key Infrastructure (PKI) is widely used. Authentication of a device based on the Public Key Infrastructure is secured by the Application layer to be free from an environment, such as a network or a device. Therefore, authentication of a device based on the Public Key Infrastructure is selected as a system most suitable for confirming a device in an IoT environment.

However, a device should include an arithmetic unit capable of creating and confirming an electronic signature to apply authentication of a device on the basis of the Public Key Infrastructure. However, it is difficult to apply the arithmetic unit to an IoT device having limited resources and capacity. Therefore, it needs to propose a method which can authenticate a device through an authentication code stored in the device regardless of device size and hardware performance by minimizing the information included in the authentication code used for authentication of the device. However, since a conventional Saju (foretelling a fortune based on year, month, date and hour of birth) information service stays on simply providing a set of abstract and ambiguous phrases analyzing a Sajumyungsik (Saju formula) without filtering, it has a problem such that users interpret the same phrases differently in their own ways. Although expert's comments are attached in some cases, the abstract and ambiguous phrases act as an element hindering the positive functions of the Saju information service, which relieves the mental stress of a user and offers a self-psychological treatment.

### SUMMARY OF THE INVENTION

An object of the proposed present invention is to easily authenticate an electronic device of a low hardware performance specification using a simplified authentication code.

Another object of the present invention is to accomplish authentication between an electronic device and a device which relays issuance of an authentication code to the electronic device, through a value calculated through a hash function using client-type information, which is information on a communication counterpart of the electronic device, and a value arbitrarily created by the electronic device.

Still another object of the present invention is to encode and decode signals transmitted and received between an electronic device and a device which relays issuance of an authentication code to the electronic device, through a default value or an add value, i.e., a random number value, and a key value.

To accomplish the above objects, according to one aspect of the present invention, there is provided an electronic device authentication manager apparatus including: a control unit for generally controlling the electronic device authentication manager apparatus; an authentication code request signal encryption unit for encrypting an authentication code request signal; an encrypted authentication code request signal transmission unit for transmitting an encrypted authentication code request signal to an electronic device; an encrypted and signed authentication code reception unit for receiving an encrypted and signed authentication code from the electronic device; an encrypted and signed authentication code decryption unit for decrypting the encrypted and signed authentication code; and an authentication code storage request signal transmission unit for transmitting an authentication code storage request signal to the electronic device, wherein the electronic device authentication manager apparatus is connected to the electronic device through a GPIO interface.

According to another aspect of the present invention, the electronic device authentication manager apparatus further includes: an electronic device chip information reception unit for receiving information on a chip installed in the electronic device from the electronic device; and a short distance wireless communication access permission unit for permitting short distance wireless communication access of the electronic device.

According to still another aspect of the present invention, the electronic device chip information reception unit may include: an electronic device chip information response signal reception unit for receiving an electronic device chip information response signal from the electronic device; and an electronic device chip version response signal reception unit for receiving an electronic device chip version response signal from the electronic device.

According to still another aspect of the present invention, the short distance wireless communication access permission unit includes: a nounce response signal reception unit for receiving a nounce response signal from the electronic device; and an electronic device information response signal reception unit for receiving an electronic device information response signal from the electronic device.

### Advantageous Effects

The proposed invention makes it easy to authenticate an electronic device of a low hardware specification using a simplified authentication code.

The proposed invention allows authentication between an electronic device and a device which relays issuance of an authentication code to the electronic device, through a value calculated through a hash function using client-type information, which is information on a communication counterpart of the electronic device, and a value arbitrarily created by the electronic device.

The proposed invention encodes and decodes signals transmitted and received between an electronic device and a device which relays issuance of an authentication code to the electronic device, through a default value or an add value, i.e., a random number value, and a key value.

### BRIEF DESCRIPTION OF THE DRAWINGS

FIG. 1 is a flowchart illustrating the flow of an electronic device authentication method according to an embodiment.

FIG. 2 is a sequence chart illustrating the operation process of an electronic device authentication method among an electronic device, an electronic device authentication manager apparatus, and an electronic device authentication server apparatus.

FIG. 3 is a view showing the information included in an authentication code according to an embodiment.

FIG. 4 is a flowchart illustrating the flow of an electronic device authentication method according to an embodiment.

FIG. 5 is a flowchart illustrating the specific flow of an electronic device chip information reception step according to an embodiment.

FIG. 6 is a sequence chart illustrating the operation process of an electronic device chip information reception step between an electronic device and an electronic device authentication manager apparatus.

FIG. 7 is a flowchart illustrating the specific flow of a short distance wireless communication access step according to an embodiment.

FIG. 8 is a sequence chart illustrating the operation process of a short distance wireless communication access step between an electronic device and an electronic device authentication manager apparatus.

FIG. 9 is a view showing the configuration of an electronic device authentication system.

FIG. 10 is a view showing the configuration of an electronic device authentication manager apparatus.

### DETAILED DESCRIPTION OF THE INVENTION

The above and additional aspects are specified through the embodiments described with reference to the accompanying drawings. It is understood that the constitutional components of the embodiments can be diversely combined within the embodiments unless mentioned otherwise or mutually contradictory. Furthermore, the proposed invention may be implemented in various different forms and is not limited to the embodiments described herein.

The elements unrelated to the description are omitted from the drawings to clearly describe the proposed invention, and similar reference symbols are assigned to similar elements throughout the specification. In addition, when an element is referred to as “including” another constitutional component, this means further including another constitutional component, not excluding another constitutional component, as far as an opposed description is not specially specified.

In addition, throughout the specification, when an element is referred to as being “connected” to another element, it also includes a case of “electrically connecting” the element with intervention of another element therebetween, as well as a case of “directly connecting” the element. Furthermore, throughout the specification, a signal means an electric quantity such as voltage, current or the like.

A unit described in this specification means a “block which configures a system of hardware or software to be changed or plugged in”, which means a unit or a block performing a specific function in hardware or software.

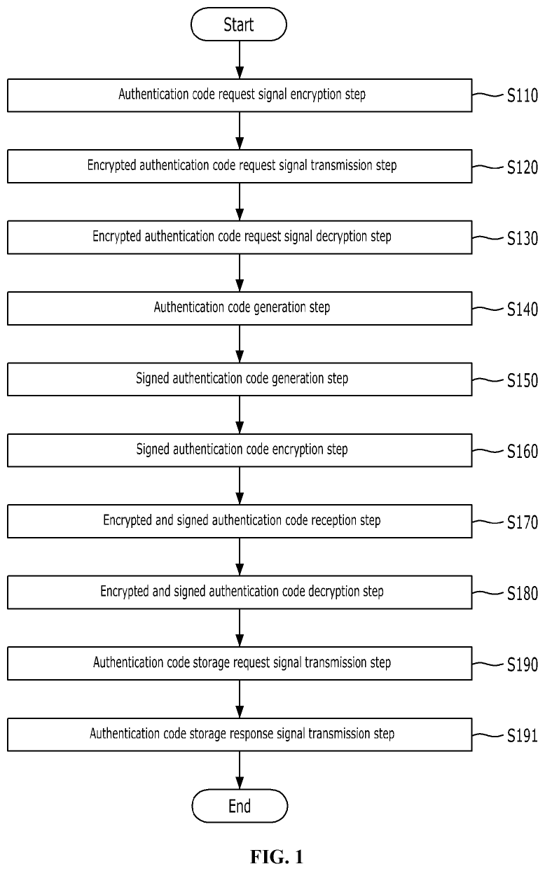

FIG. 1 is a flowchart illustrating the flow of an electronic device 100 authentication method according to an embodiment.

In an aspect, an electronic device 100 authentication method includes: an authentication code request signal encryption step (step S110), an encrypted authentication code request signal transmission step (step S120), an encrypted authentication code request signal decryption step (step S130), an authentication code generation step (step S140), a signed authentication code generation step (step S150), a signed authentication code encryption step (step S160), an encrypted and signed authentication code reception step (step S170), an encrypted and signed authentication code decryption step (step S180), a signed authentication code transmission step, and an authentication code storage response signal transmission step.

In an embodiment, at the authentication code request signal encryption step (step S110), an electronic device authentication manager apparatus 110 encrypts an authentication code request signal. The authentication code request signal encryption step (step S110) is a step of encrypting the authentication code request signal itself.

Since information on the electronic device 100 described below is included in the authentication code request signal, the authentication code request signal itself is encrypted for the reason of security. The electronic device authentication manager apparatus 110 relays the process of receiving an authentication code for authenticating the electronic device 100 issued by an electronic device authentication server 120 apparatus. That is, the electronic device authentication manager apparatus 110 receives an authentication code from the electronic device authentication server 120 apparatus and transmits the authentication code to the electronic device 100. The electronic device authentication manager apparatus 110 is a terminal, for example, such as a cellular phone, a notebook computer or the like. The electronic device authentication manager apparatus 110 intermediates the electronic device 100 and the electronic device authentication server 120 apparatus through an application installed in the terminal so that the electronic device 100 may receive and store a signed authentication code.

The authentication code request signal includes at least one among a message type, a message length, a serial number, a gateway ID, a unique ID, and an electronic device 100 password. The message type, the message length, the serial number, the gateway ID, the unique ID, and the electronic device 100 password are information that the authentication code request signal includes.

The message type is a value set in the first byte of all request signals or response signals, which is a value identifying a type of an authentication code request signal. Here, the message type is a type of a signal. That is, the message type is a value set in the first byte of the authentication code request signal, and a type of the signal is distinguished according to the value. For example, the message type of the authentication code request signal is qw06. The electronic device authentication manager apparatus 110 receiving a signal, the first byte of which is set to qw06, may recognize the signal as an authentication code request signal.

The message length is a message size subtracting the message type and the message length from the total message size. It has been described above that the authentication code request signal includes various kinds of other information, in addition to the message type and the message length. Here, the message length is a size subtracting a size corresponding to the message type and a size corresponding to the message length from the size, i.e., the length, of all the information that the authentication code request signal includes. If the size of the message type is one byte, the size of the message length itself is four bytes, and the size of the total message is 85 bytes, the message length is 80 bytes. Here, the size of the total message is the size of the authentication code request signal.

The serial number is a unique number of the electronic device 100. Every electronic device 100 capable of performing short distance wireless communication or wired communication with the electronic device authentication manager apparatus 110 includes a unique number. The electronic device authentication manager apparatus 110 receives and stores a serial number, which is a unique number of the electronic device 100, at a step before the authentication code request signal encryption step (step S110) described below. The electronic device authentication manager apparatus 110 creates an authentication code request signal including the serial number stored therein.

The gateway ID is an ID of a gateway which performs short distance wireless communication or wired communication with the electronic device 100. After the electronic device 100 stores a signed authentication code created by the electronic device authentication server 120 apparatus, the electronic device 100 is authenticated by the gateway through the signed authentication code. The gateway is installed by region. For example, the gateway is installed in a specific building, and the electronic device 200 should be authenticated by the gateway to communicate with the gateway in the specific building. The gateway ID is an ID of a gateway communicating with the electronic device 100 in a space where the electronic device 100 will be used.

The unique ID is an ID of a chip installed in the electronic device 100. The unique ID is information created by the electronic device 100. The unique ID is a result of applying a hash to a result of applying a salt to the serial number of the electronic device 100, in which a chip is installed. It has been described above that every electronic device 100 has a serial number, which is a unique number. The salt is a value set by a user, which is a value not to expose a relationship between the serial number and the unique ID. Applying a salt is performing a logical operation using a serial number and a value specified by a user, for example, a salt value ‘1234’ and a serial number. A result of applying a hash function to a result of performing a logical operation on the salt value and the serial number is the unique ID. The logical operation is at least one among ‘and’, ‘or’, ‘xor’ and ‘nand’.

The electronic device 100 password is a value that should be inputted when the electronic device 100 stores the received signed authentication code at the authentication code storage response signal transmission step described below. When the electronic device 100 stores the signed authentication code, the signed authentication code only may be stored when a password identical to the electronic device 100 password included in the authentication code request signal is inputted.

In an embodiment, at the encrypted authentication code request signal transmission step (step S120), the electronic device authentication manager apparatus 110 transmits an encrypted authentication code request signal to the electronic device authentication server 120 apparatus. The authentication code request signal has been described above in detail.

In an embodiment, at the encrypted authentication code request signal decryption step (step S130), the electronic device authentication server 120 apparatus decrypts the encrypted authentication code request signal that is received. The electronic device authentication server 120 apparatus recognizes that the signal transmitted from the electronic device authentication manager apparatus 110 is a signal requesting an authentication code, through the message type included in the encrypted authentication code request signal that is decrypted.

In an embodiment, at the authentication code generation step (step S140), the electronic device authentication server 120 apparatus creates an authentication code according to the authentication code request signal. The electronic device authentication server 120 apparatus creates an authentication code including some of the information included in the authentication code request signal transmitted from the electronic device authentication manager apparatus 110. The electronic device authentication server 120 apparatus is a device which creates an authentication code. The electronic device authentication server 120 apparatus is a server device of an organization qualified to create an authentication code. Specific information included in the authentication code will be described below in detail.

In an embodiment, at the signed authentication code generation step (step S150), the electronic device authentication server 120 apparatus creates a signed authentication code by signing the authentication code that is created. Since the authentication code itself created by the electronic device authentication server 120 apparatus can be replicated, the electronic device authentication server 120 apparatus signs the authentication code. The signed authentication code means an authentication code that is created by the electronic device authentication server 120 apparatus itself. That the electronic device authentication server 120 apparatus signs the authentication code means that the authentication code includes a signature-related data.

In an embodiment, at the signed authentication code encryption step (step S160), the electronic device authentication server 120 apparatus encrypts the signed authentication code. The electronic device authentication server 120 apparatus encrypts the signed authentication code using an encryption algorithm included in the authentication code. For security purpose, the signed authentication code is managed by encrypting the code.

In an embodiment, at the encrypted and signed authentication code reception step (step S170), the electronic device authentication manager apparatus 110 receives the encrypted and signed authentication code from the electronic device authentication server 120 apparatus. At the encrypted and signed authentication code reception step (step S170), the electronic device authentication manager apparatus 110 also receives a result code, an authentication code size, and a hashed electronic device 100 password, in addition to the signed authentication code. The result code is a value indicating whether the electronic device authentication server 120 apparatus has received the encrypted authentication code request signal from the electronic device authentication manager apparatus 110 without an error. The authentication code size means the size of the authentication code itself. The size of the authentication code is, for example, 1,000 bytes. The hashed electronic device 100 password is a result of applying a hash function to the electronic device 100 password described above. To prevent theft of the electronic device 100 password itself, a hash is applied, and the electronic device authentication server 120 apparatus transmits the hashed electronic device 100 password.

In an embodiment, at the encrypted and signed authentication code decryption step (step S180), the electronic device authentication manager apparatus 110 decrypts the encrypted and signed authentication code. Since an encryption algorithm, which is information showing how the authentication code is encrypted, is included in the authentication code itself, the electronic device authentication manager apparatus 110 decrypts the encrypted and signed authentication code using the encryption algorithm.

In an embodiment, at an authentication code storage request signal transmission step (step S190), the electronic device authentication manager apparatus 110 confirms the signed authentication code and transmits an authentication code storage request signal to the electronic device 100. Confirming the signed authentication code is comparing the information included in the authentication code and the information included in the authentication code request signal by the electronic device authentication manager apparatus 110. For example, both the authentication code request signal and the authentication code include a unique ID, and it is confirming whether the unique IDs are identical.

The authentication code storage request signal includes a message type, a message length, an authentication code size, an authentication code, electronic device 100 information request command information, an electronic device 100 password, a hashed electronic device 100 password, and a session ID.

The message type is a value set in the first byte of all request signals or response signals, which is a value identifying a type of an authentication code storage request signal. Here, the message type is a type of a signal. That is, the message type is a value set in the first byte of the authentication code storage request signal, and a type of the signal is distinguished according to the value. For example, the message type of the authentication code storage request signal is qw07. The electronic device 100 receiving a signal, the first byte of which is set to qw07, may recognize the signal as an authentication code storage request signal.

The message length is a message size subtracting the message type and the message length from the total message size. Here, the size is a length. It has been described above that the authentication code storage request signal includes various kinds of other information, in addition to the message type and the message length. Here, the message length is a size subtracting a size corresponding to the message type and a size corresponding to the message length from the size, i.e., the length, of all the information that the authentication code storage request signal includes. If the size of the message type is one byte, the size of the message length itself is four bytes, and the size of the total message is 85 bytes, the message length is 80 bytes. Here, the size of the total message is the size of the authentication code storage request signal.

The authentication code size is the capacity of a certificate itself, and for example, the authentication code size is 1,000 bytes.

The authentication code is an authentication code created by the electronic device authentication server 120 apparatus described above.

The electronic device 100 information request command information is obtained by performing a logical operation on the client type and a nounce previously stored in the electronic device authentication manager apparatus 110 and applying a hash thereto by the electronic device authentication manager apparatus 110. That is, the electronic device 100 information request command information is obtained by performing Hash (client type|nounce). Here, the nounce is the current time or a random number arbitrarily generated by the electronic device authentication manager apparatus 110. Applying a hash or applying a hash function to a certain value means performing Hash (certain value). Applying a hash or applying a hash function to a certain value after performing a logical operation on a first value and a second value is performing Hash (first value|second value).

The electronic device 100 password is a value that should be inputted when the electronic device 100 stores the received signed authentication code at the authentication code storage response signal transmission step described below. When the electronic device 100 stores the signed authentication code, the signed authentication code only may be stored when a password identical to the electronic device 100 password included in the authentication code request signal is inputted.

The hashed electronic device 100 password is a result of applying a hash function to the electronic device 100 password.

The session ID is an ID calculated by the electronic device authentication manager apparatus 110 by applying a hash function to a result of a logical operation performed on a transaction ID, a serial number, a client type and a nounce. Here, the nounce is the time at the time point of creating the session ID or a random number arbitrarily generated by the electronic device authentication manager apparatus 110.

In an embodiment, at the authentication code storage response signal transmission step, the electronic device 100 stores the signed authentication code that is received and transmits an authentication code storage response signal to the electronic device authentication manager apparatus 110. The authentication code storage response signal includes a message type, a message length, and a result code.

The message type is a value set in the first byte of all request signals or response signals, which is a value identifying a type of an authentication code storage response signal. Here, the message type is a type of a signal. That is, the message type is a value set in the first byte of the authentication code storage response signal, and a type of the signal is distinguished according to the value. For example, the message type of the authentication code storage response signal is qw87. The electronic device 100 receiving a signal, the first byte of which is set to qw87, may recognize the signal as an authentication code storage response signal.

The message length is a message size subtracting the message type and the message length from the total message size. Here, the size is a length. It has been described above that the authentication code storage response signal includes various kinds of other information, in addition to the message type and the message length. Here, the message length is a size subtracting a size corresponding to the message type and a size corresponding to the message length from the size, i.e., the length, of all the information that the authentication code storage response signal includes. If the size of the message type is one byte, the size of the message length itself is four bytes, and the size of the total message is 85 bytes, the message length is 80 bytes. Here, the size of the total message is the size of the authentication code storage response signal.

The result code is a code indicating whether the authentication code is stored without an error. For example, if the result code is 0, it means that the authentication code is stored in the electronic device 100 without an error.

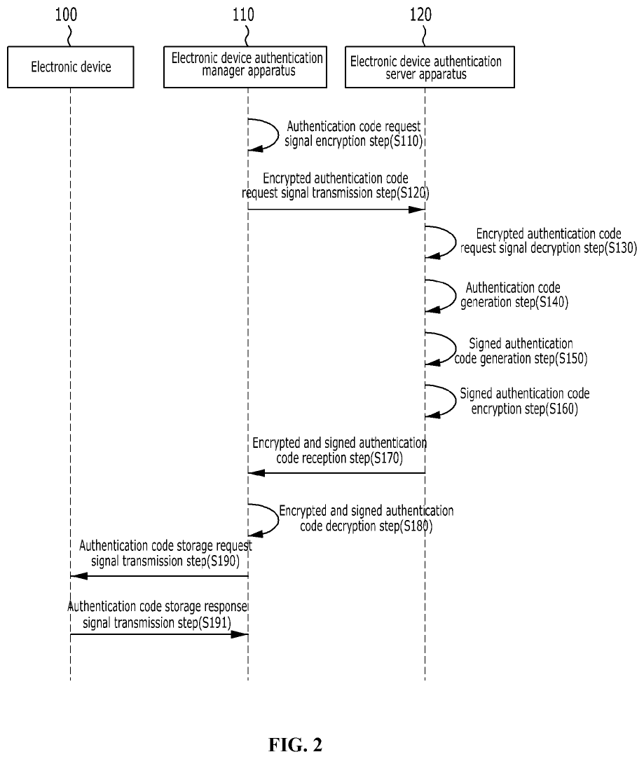

FIG. 2 is a sequence chart illustrating the operation process of an electronic device 100 authentication method among an electronic device 100, an electronic device authentication manager apparatus 110, and an electronic device authentication server 120 apparatus.

The encrypted authentication code request signal transmission step and the encrypted and signed authentication code reception step described below may be performed between the electronic device and the electronic device authentication server apparatus.

That is, the electronic device authentication manager apparatus 110 may perform only a function of encrypting an authentication code request signal and decrypting an encrypted and signed authentication code after connecting to an electronic device through a GPIO interface.

The electronic device may transmit an authentication code request signal encrypted by the electronic device authentication manager apparatus to the electronic device authentication server apparatus.

In addition, the electronic device may transmit an encrypted and signed authentication code, which is decrypted by the electronic device authentication manager apparatus, to the electronic device authentication server apparatus.

In an embodiment, at the authentication code request signal encryption step (step S110), an electronic device authentication manager apparatus 110 encrypts an authentication code request signal. The authentication code request signal encryption step (step S110) is a step of encrypting the authentication code request signal itself. Since information on the electronic device 100 described below is included in the authentication code request signal, the authentication code request signal itself is encrypted for the reason of security. The electronic device authentication manager apparatus 110 relays the process of receiving an authentication code for authenticating the electronic device 100 issued by an electronic device authentication server 120 apparatus. That is, the electronic device authentication manager apparatus 110 receives an authentication code from the electronic device authentication server 120 apparatus and transmits the authentication code to the electronic device 100. The electronic device authentication manager apparatus 110 is a terminal, for example, such as a cellular phone, a notebook computer or the like. The electronic device authentication manager apparatus 110 intermediates the electronic device 100 and the electronic device authentication server 120 apparatus through an application installed in the terminal so that the electronic device 100 may receive and store a signed authentication code.

The authentication code request signal includes a message type, a message length, a serial number, a gateway ID, a unique ID, and an electronic device 100 password. The message type, the message length, the serial number, the gateway ID, the unique ID, and the electronic device 100 password are information that the authentication code request signal includes.

The message type is a value set in the first byte of all request signals or response signals, which is a value identifying a type of an authentication code request signal. Here, the message type is a type of a signal. That is, the message type is a value set in the first byte of the authentication code request signal, and a type of the signal is distinguished according to the value. For example, the message type of the authentication code request signal is qw06. The electronic device authentication manager apparatus 110 receiving a signal, the first byte of which is set to qw06, may recognize the signal as an authentication code request signal.

The message length is a message size subtracting the message type and the message length from the total message size. It has been described above that the authentication code request signal includes various kinds of other information, in addition to the message type and the message length. Here, the message length is a size subtracting a size corresponding to the message type and a size corresponding to the message length from the size, i.e., the length, of all the information that the authentication code request signal includes. If the size of the message type is one byte, the size of the message length itself is four bytes, and the size of the total message is 85 bytes, the message length is 80 bytes. Here, the size of the total message is the size of the authentication code request signal.

The serial number is a unique number of the electronic device 100. Every electronic device 100 capable of performing short distance wireless communication or wired communication with the electronic device authentication manager apparatus 110 includes a unique number. The electronic device authentication manager apparatus 110 receives and stores a serial number, which is a unique number of the electronic device 100, at a step before the authentication code request signal encryption step (step S110) described below. The electronic device authentication manager apparatus 110 creates an authentication code request signal including the serial number stored therein.

The gateway ID is an ID of a gateway which performs short distance wireless communication or wired communication with the electronic device 100. After the electronic device 100 stores a signed authentication code created by the electronic device authentication server 120 apparatus, the electronic device 100 is authenticated by the gateway through the signed authentication code. The gateway is installed by region. For example, the gateway is installed in a specific building, and the electronic device 200 should be authenticated by the gateway to communicate with the gateway in the specific building. The gateway ID is an ID of a gateway communicating with the electronic device 100 in a space where the electronic device 100 will be used.

The unique ID is an ID of a chip installed in the electronic device 100. The unique ID is information created by the electronic device 100. The unique ID is a result of applying a hash to a result of applying a salt to the serial number of the electronic device 100, in which a chip is installed. It has been described above that every electronic device 100 has a serial number, which is a unique number. The salt is a value set by a user, which is a value not to expose a relationship between the serial number and the unique ID. Applying a salt is performing a logical operation using a serial number and a value specified by a user, for example, a salt value ‘1234’ and a serial number. A result of applying a hash function to a result of performing a logical operation on the salt value and the serial number is the unique ID.

The electronic device 100 password is a value that should be inputted when the electronic device 100 stores the received signed authentication code at the authentication code storage response signal transmission step described below. When the electronic device 100 stores the signed authentication code, the signed authentication code only may be stored when a password identical to the electronic device 100 password included in the authentication code request signal is inputted.

In an embodiment, at the encrypted authentication code request signal transmission step (step S120), the electronic device authentication manager apparatus 110 transmits an encrypted authentication code request signal to the electronic device authentication server 120 apparatus. The authentication code request signal has been described above in detail.

In an embodiment, at the encrypted authentication code request signal decryption step (step S130), the electronic device authentication server 120 apparatus decrypts the encrypted authentication code request signal that is received. The electronic device authentication server 120 apparatus recognizes that the signal transmitted from the electronic device authentication manager apparatus 110 is a signal requesting an authentication code, through the message type included in the encrypted authentication code request signal that is decrypted.

In an embodiment, at the authentication code generation step (step S140), the electronic device authentication server 120 apparatus creates an authentication code according to the authentication code request signal. The electronic device authentication server 120 apparatus creates an authentication code including some of the information included in the authentication code request signal transmitted from the electronic device authentication manager apparatus 110. The electronic device authentication server 120 apparatus is a device which creates an authentication code. The electronic device authentication server 120 apparatus is a server device of an organization qualified to create an authentication code. Specific information included in the authentication code will be described below in detail.

In an embodiment, at the signed authentication code generation step (step S150), the electronic device authentication server 120 apparatus creates a signed authentication code by signing the authentication code that is created. Since the authentication code itself created by the electronic device authentication server 120 apparatus can be replicated, the electronic device authentication server 120 apparatus signs the authentication code. The signed authentication code means an authentication code that is created by the electronic device authentication server 120 apparatus itself. That the electronic device authentication server 120 apparatus signs the authentication code means that the authentication code includes a signature-related data.

In an embodiment, at the signed authentication code encryption step (step S160), the electronic device authentication server 120 apparatus encrypts the signed authentication code. The electronic device authentication server 120 apparatus encrypts the signed authentication code using an encryption algorithm included in the authentication code. For security purpose, the signed authentication code is managed by encrypting the code.

In an embodiment, at the encrypted and signed authentication code reception step (step S170), the electronic device authentication manager apparatus 110 receives the encrypted and signed authentication code from the electronic device authentication server 120 apparatus. At the encrypted and signed authentication code reception step (step S170), the electronic device authentication manager apparatus 110 also receives a result code, an authentication code size, and a hashed electronic device 100 password, in addition to the signed authentication code. The result code is a value indicating whether the electronic device authentication server 120 apparatus has received the encrypted authentication code request signal from the electronic device authentication manager apparatus 110 without an error. The authentication code size means the size of the authentication code itself. The size of the authentication code is, for example, 1,000 bytes. The hashed electronic device 100 password is a result of applying a hash function to the electronic device 100 password described above. To prevent theft of the electronic device 100 password itself, a hash is applied, and the electronic device authentication server 120 apparatus transmits the hashed electronic device 100 password.

In an embodiment, at the encrypted and signed authentication code decryption step (step S180), the electronic device authentication manager apparatus 110 decrypts the encrypted and signed authentication code. Since an encryption algorithm, which is information showing how the authentication code is encrypted, is included in the authentication code itself, the electronic device authentication manager apparatus 110 decrypts the encrypted and signed authentication code using the encryption algorithm.

In an embodiment, at an authentication code storage request signal transmission step S190, the electronic device authentication manager apparatus 110 confirms the signed authentication code and transmits an authentication code storage request signal to the electronic device 100. Confirming the signed authentication code is comparing the information included in the authentication code and the information included in the authentication code request signal by the electronic device authentication manager apparatus 110. For example, both the authentication code request signal and the authentication code include a unique ID, and it is confirming whether the unique IDs are identical.

The authentication code storage request signal includes a message type, a message length, an authentication code size, an authentication code, electronic device 100 information request command information, an electronic device 100 password, a hashed electronic device 100 password, and a session ID.

The message type is a value set in the first byte of all request signals or response signals, which is a value identifying a type of an authentication code storage request signal. Here, the message type is a type of a signal. That is, the message type is a value set in the first byte of the authentication code storage request signal, and a type of the signal is distinguished according to the value. For example, the message type of the authentication code storage request signal is qw07. The electronic device 100 receiving a signal, the first byte of which is set to qw07, may recognize the signal as an authentication code storage request signal.

The message length is a message size subtracting the message type and the message length from the total message size. Here, the size is a length. It has been described above that the authentication code storage request signal includes various kinds of other information, in addition to the message type and the message length. Here, the message length is a size subtracting a size corresponding to the message type and a size corresponding to the message length from the size, i.e., the length, of all the information that the authentication code storage request signal includes. If the size of the message type is one byte, the size of the message length itself is four bytes, and the size of the total message is 85 bytes, the message length is 80 bytes. Here, the size of the total message is the size of the authentication code storage request signal.

The authentication code size is the capacity of a certificate itself, and for example, the authentication code size is 1,000 bytes.

The authentication code is an authentication code created by the electronic device authentication server 120 apparatus described above.

The electronic device 100 information request command information is obtained by performing a logical operation on the client type and a nounce previously stored in the electronic device authentication manager apparatus 110 and applying a hash thereto by the electronic device authentication manager apparatus 110. That is, the electronic device 100 information request command information is obtained by performing Hash (client type|nounce). Here, the nounce is the current time or a random number arbitrarily generated by the electronic device authentication manager apparatus 110. Applying a hash or applying a hash function to a certain value means performing Hash (certain value). Applying a hash or applying a hash function to a certain value after performing a logical operation on a first value and a second value is performing Hash (first value|second value).

The electronic device 100 password is a value that should be inputted when the electronic device 100 stores the received signed authentication code at the authentication code storage response signal transmission step described below. When the electronic device 100 stores the signed authentication code, the signed authentication code only may be stored when a password identical to the electronic device 100 password included in the authentication code request signal is inputted.

The hashed electronic device 100 password is a result of applying a hash function to the electronic device 100 password.

The session ID is an ID calculated by the electronic device authentication manager apparatus 110 by applying a hash function to a result of a logical operation performed on a transaction ID, a serial number, a client type and a nounce. Here, the nounce is the time at the time point of creating the session ID or a random number arbitrarily generated by the electronic device authentication manager apparatus 110.

In an embodiment, at the authentication code storage response signal transmission step, the electronic device 100 stores the signed authentication code that is received and transmits an authentication code storage response signal to the electronic device authentication manager apparatus 110. The authentication code storage response signal includes a message type, a message length, and a result code.

The message type is a value set in the first byte of all request signals or response signals, which is a value identifying a type of an authentication code storage response signal. Here, the message type is a type of a signal. That is, the message type is a value set in the first byte of the authentication code storage response signal, and a type of the signal is distinguished according to the value. For example, the message type of the authentication code storage response signal is qw87. The electronic device 100 receiving a signal, the first byte of which is set to qw87, may recognize the signal as an authentication code storage response signal.

The message length is a message size subtracting the message type and the message length from the total message size. Here, the size is a length. It has been described above that the authentication code storage response signal includes various kinds of other information, in addition to the message type and the message length. Here, the message length is a size subtracting a size corresponding to the message type and a size corresponding to the message length from the size, i.e., the length, of all the information that the authentication code storage response signal includes. If the size of the message type is one byte, the size of the message length itself is four bytes, and the size of the total message is 85 bytes, the message length is 80 bytes. Here, the size of the total message is the size of the authentication code storage response signal.

The result code is a code indicating whether the authentication code is stored without an error. For example, if the result code is 0, it means that the authentication code is stored in the electronic device 100 without an error.

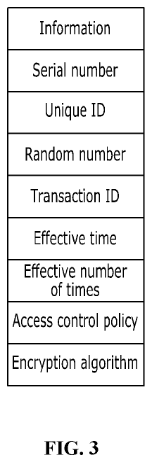

FIG. 3 is a view showing the information included in an authentication code according to an embodiment.

In an embodiment, an authentication code includes a serial number, a unique ID, a random number, a transaction ID, an effective time, an effective number of times, an access control policy, and an encryption algorithm. That is, the authentication code includes a plurality pieces of information, and the plurality pieces of information is the serial number, the unique ID, the random number, the transaction ID, the effective time, the effective number of times, the access control policy, and the encryption algorithm.

The serial number is a unique number of the electronic device 100. Every electronic device 100 capable of performing short distance wireless communication or wired communication with the electronic device authentication manager apparatus 110 includes a unique number. The electronic device authentication manager apparatus 110 receives and stores a serial number, which is a unique number of the electronic device 100, at a step before the authentication code request signal encryption step (step S110) described below. The electronic device authentication manager apparatus 110 creates an authentication code request signal including the serial number stored therein.

The unique ID is an ID of a chip installed in the electronic device 100. The unique ID is information created by the electronic device 100. The unique ID is a result of applying a hash to a result of applying a salt to the serial number of the electronic device 100, in which a chip is installed. It has been described above that every electronic device 100 has a serial number, which is a unique number. The salt is a value set by a user, which is a value not to expose a relationship between the serial number and the unique ID. Applying a salt is performing a logical operation using a serial number and a value specified by a user, for example, a salt value ‘1234’ and a serial number. A result of applying a hash function to a result of performing a logical operation on the salt value and the serial number is the unique ID.

The random number is a random number value, which is a value generated by the electronic device authentication manager apparatus 110.

The transaction ID is an ID which means how many signals has the electronic device authentication server 120 apparatus received before a signal including the transaction ID. The electronic device authentication server 120 apparatus communicates with one or more electronic device authentication manager apparatuses 110a and creates an authentication code. The electronic device authentication server 120 apparatus may receive an encrypted authentication code request signal one or more times from a plurality of electronic device authentication manager apparatuses 110. The number of times that the electronic device authentication server 120 apparatus receives the authentication code request through the encrypted authentication code request signal is at least one. The electronic device authentication server 120 apparatus creates an authentication code including a transaction ID by creating the transaction ID in order of receiving the encrypted authentication code request signal.

The effective time is the effective period of the authentication code. The electronic device authentication server 120 apparatus may diversely set the effective time according to the type of the electronic device 100 and the location of using the electronic device 100. The electronic device 100 can be used during the effective time starting from the time point of storing the signed authentication code in the electronic device 100. The effective time is, for example, one year.

The effective number of times is the maximum number of communications when the electronic device 100, in which the signed authentication code is stored, communicates with a gateway installed at a specific location to be used at the specific location. If the effective number of times is five, the electronic device 100 may communicate with the gateway five times.

The access control policy is information indicating which gateway the electronic device 100 may connect to. Each electronic device 100 may be classified as an electronic device 100 capable of communicating with all gateways or an electronic device 100 capable of connecting only to a specific gateway. The access control policy may include, for example, an ID of a gateway that can be or cannot be accessed by the electronic device 100.

The encryption algorithm is information indicating which encryption algorithm is used to encrypt a signed authentication code when the electronic device authentication server 120 apparatus encrypts the signed authentication code. The electronic device authentication manager apparatus 110 decrypts the encrypted and signed authentication code through the encryption algorithm included in the authentication code.

The authentication code according to the present invention includes only minimum information needed to authenticate the electronic device 100 unlike conventional authentication codes and includes the effective time and the effective number of times, which are information distinguished from the conventional authentication codes.

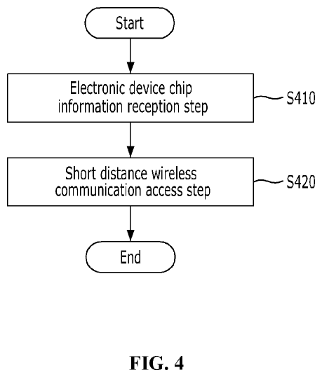

FIG. 4 is a flowchart illustrating the flow of an electronic device 100 authentication method according to an embodiment.

In an aspect, the electronic device 100 authentication method may further include an electronic device 100 chip information reception step (step S410) and a short distance wireless communication access step (step S420) before the authentication code request signal encryption step (step S110). The electronic device 100 authentication method shown in FIG. 1 shows the flow of the process in which the electronic device 100 receives an authentication code from the electronic device authentication server 120 apparatus. Before the electronic device 100 receives an authentication code from the electronic device authentication server 120 apparatus, the electronic device 100 should wirelessly communicate with the electronic device authentication manager apparatus 110. That is, the flowchart shown in FIG. 4 shows the process in which the electronic device 100 accesses the electronic device authentication manager apparatus 110 before the electronic device 100 receives the authentication code according to FIG. 1.

In an embodiment, at the electronic device 100 chip information reception step (step S410), the electronic device 100 authentication manager apparatus receives information on the chip installed in the electronic device 100. The detailed process thereof will be described below.

In an embodiment, at the short distance wireless communication access step (step S420), the electronic device 100 authentication manager apparatus allows short distance wireless communication access of the electronic device 100. When the electronic device 100 information request command information included in the electronic device 100 information request signal described below matches the electronic device 100 information request command information created by the electronic device 100, the electronic device authentication manager apparatus 110 allows short distance wireless communication access of the electronic device 100. The detailed process thereof will be described below.

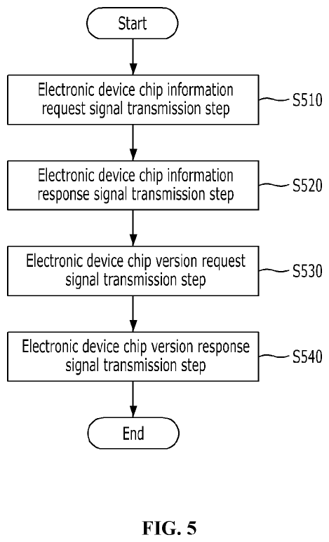

FIG. 5 is a flowchart illustrating the specific flow of an electronic device 100 chip information reception step (step S410) according to an embodiment.

In an aspect, an electronic device 100 chip information reception step includes an electronic device 100 chip information request signal transmission step (step S510), an electronic device 100 chip information response signal transmission step (step S520), an electronic device 100 chip version request signal transmission step (step S530), an electronic device 100 chip version response signal transmission step (step S540).

In an embodiment, at the electronic device 100 chip information request signal transmission step (step S510), the electronic device authentication manager apparatus 110 transmits an electronic device 100 chip information request signal to the electronic device 100. The electronic device 100 chip information request signal includes a message type, a check ID and other information.

The message type is a value set in the first byte of all request signals or response signals, which is a value identifying a type of an electronic device 100 chip information request signal. Here, the message type is a type of a signal. That is, the message type is a value set in the first byte of the electronic device 100 chip information request signal, and a type of the signal is distinguished according to the value. For example, the message type of the electronic device 100 chip information request signal is qwE0. The electronic device 100 receiving a signal, the first byte of which is set to qwE0, may recognize the signal as an electronic device 100 chip information request signal.

The check ID is an ID calculated by applying a hash function to a result of a logical operation performed on a value, which is calculated by adding the current time to the name of the electronic device authentication manager apparatus 110, and a salt value. That is, the electronic device authentication manager apparatus 110 calculates the check ID through Hash (salt|name of device authentication manager apparatus 110, current time).

The other information includes the name of the electronic device authentication manager apparatus 110 and the current time.

In an embodiment, at the electronic device 100 chip information response signal transmission step (step S520), the electronic device 100 transmits an electronic device 100 chip information response signal to the electronic device authentication manager apparatus 110. The electronic device 100 chip information response signal includes a message type, a check ID and other information.

The message type is a value set in the first byte of all request signals or response signals, which is a value identifying a type of an electronic device 100 chip information response signal. Here, the message type is a type of a signal. That is, the message type is a value set in the first byte of the electronic device 100 chip information response signal, and a type of the signal is distinguished according to the value. For example, the message type of the electronic device 100 chip information response signal is qwE0. The electronic device authentication manager apparatus 110 receiving a signal, the first byte of which is set to qwE0, may recognize the signal as an electronic device 100 chip information response signal.

The check ID is an ID calculated by applying a hash function to a result of a logical operation performed on a salt value, a serial number, an add value and a key value. That is, the electronic device 100 calculates the check ID through Hash (salt value|serial number|add value|key value). Here, the add value and the key value are random numbers generated by the electronic device 100.

The other information includes a serial number, an add value and a key value.

In an embodiment, at the electronic device 100 chip version request signal transmission step (step S530), the electronic device authentication manager apparatus 110 transmits an electronic device 100 chip version request signal to the electronic device 100.

The message type is a value set in the first byte of all request signals or response signals, which is a value identifying a type of an electronic device 100 chip version request signal. Here, the message type is a type of a signal. That is, the message type is a value set in the first byte of the electronic device 100 chip version request signal, and a type of the signal is distinguished according to the value. For example, the message type of the electronic device 100 chip version request signal is qwE1. The electronic device 100 receiving a signal, the first byte of which is set to qwE1, may recognize the signal as an electronic device 100 chip version request signal.

The check ID is an ID calculated by applying a hash function to a result of a logical operation performed on a salt value, the name of the electronic device authentication manager apparatus 110, a version, and the current time. That is, the electronic device authentication manager apparatus 110 calculates the check ID through Hash (salt value|name of device authentication manager apparatus 110|version|current time). The version is the version value of a version of the electronic device 100 authentication method. For example, if the current version is 1.0, the version value is qw01.

The other information includes the name, the version and the current time of the electronic device authentication manager apparatus 110.

In an embodiment, at the electronic device 100 chip version response signal transmission step (step S540), the electronic device 100 transmits an electronic device 100 chip version response signal to the electronic device authentication manager apparatus 110. The electronic device 100 chip version response signal includes a message type, a check ID and other information.

The message type is a value set in the first byte of all request signals or response signals, which is a value identifying a type of an electronic device 100 chip version response signal. Here, the message type is a type of a signal. That is, the message type is a value set in the first byte of the electronic device 100 chip version response signal, and a type of the signal is distinguished according to the value. For example, the message type of the electronic device 100 version response signal is qwE1. The electronic device authentication manager apparatus 110 receiving a signal, the first byte of which is set to qwE1, may recognize the signal as an electronic device 100 chip version response signal.

The check ID is an ID calculated by applying a hash function to a result of a logical operation performed on a salt value, a serial number, and a version. That is, the electronic device 100 calculates the check ID through Hash (salt value|serial number|version). Here, the version is the same as the version included in the electronic device 100 chip version request signal at the electronic device 100 chip version request signal transmission step. The salt value is a value set by the electronic device 100 or the electronic device authentication manager apparatus, which can be freely set.

The other information includes a serial number and a version.

In an embodiment, at the electronic device 100 chip information request signal transmission step (step S510), the electronic device authentication manager apparatus 110 performs encryption by performing a logical operation, using a key value of a default value, on a result of adding the data included in the electronic device 100 chip information request signal and an add value of a default value, and transmits the encrypted electronic device 100 chip information request signal.

The electronic device authentication manager apparatus 110 encrypts the electronic device 100 chip information request signal in an encryption method described above and transmits the encrypted electronic device 100 chip information request signal to the electronic device 100. That is, the electronic device authentication manager apparatus 110 encrypts the data included in the electronic device 100 chip information request signal through an operation of “(data included in electronic device 100 chip information request signal+add value), logical operation, key value”. The logical operation is at least one among ‘and’, ‘or’, ‘xor’ and ‘nand’. Encrypting the data included in the electronic device 100 chip information request signal means the same as encrypting the electronic device 100 chip information request signal. Here, the add value and the key value are default values. For example, the default value of the add value is qw1234, and the default value of the key value is qw7445.

The electronic device 100 receiving the encrypted electronic device 100 chip information request signal decrypts the encrypted electronic device 100 chip information request signal. The electronic device 100 calculates the data included in the electronic device 100 chip information request signal by performing a logical operation on the data and the key value included in the encrypted electronic device 100 chip information request signal and subtracting the add value. That is, the electronic device 100 obtains the data included in the electronic device 100 chip information request signal through an operation of “(data included in the electronic device 100 chip information request signal, logical operation, key value)−add value”.

In an embodiment, at the electronic device 100 chip information response signal transmission step (step S520), the electronic device 100 performs encryption by performing a logical operation, using a key value of a default value, on a result of adding the data included in the electronic device 100 chip information response signal and the add value of a default value and transmits the encrypted electronic device 100 chip information response signal.

The electronic device 100 encrypts the electronic device 100 chip information response signal in an encryption method described above and transmits the encrypted electronic device 100 chip information response signal to the electronic device authentication manager apparatus 110. That is, the electronic device 100 encrypts the data included in the electronic device 100 chip information response signal through an operation of “(data included in electronic device 100 chip information response signal+add value), logical operation, key value”. Encrypting the data included in the electronic device 100 chip information response signal means the same as encrypting the electronic device 100 chip information response signal. Here, the add value and the key value are random numbers generated by the electronic device 100.

The electronic device authentication manager apparatus 110 receiving the encrypted electronic device 100 chip information response signal decrypts the encrypted electronic device 100 chip information response signal. The electronic device authentication manager apparatus 110 calculates the data included in the electronic device 100 chip information response signal by performing a logical operation on the data and the key value included in the encrypted electronic device 100 chip information response signal and subtracting the add value. That is, the electronic device authentication manager apparatus 110 obtains the data included in the electronic device 100 chip information response signal through an operation of “(data included in the electronic device 100 chip information response signal, logical operation, key value)−add value”. Since the electronic device authentication manager apparatus 110 receives the add value and the key value included in the electronic device 100 chip information response signal transmitted from the electronic device 100, it can perform decryption through the add value and the key value.

In an embodiment, at the electronic device 100 chip version request signal transmission step (step S530), the electronic device authentication manager apparatus 110 performs encryption by performing a logical operation, using the key value included in the electronic device 100 chip information response signal, on a result of adding the data included in the electronic device 100 chip version request signal and the add value included in the electronic device 100 chip information response signal, and transmits the encrypted electronic device 100 chip version request signal.

The electronic device authentication manager apparatus 110 encrypts the electronic device 100 chip version request signal in an encryption method described above and transmits the encrypted electronic device 100 chip version request signal to the electronic device 100. That is, the electronic device authentication manager apparatus 110 encrypts the data included in the electronic device 100 chip version request signal through an operation of “(data included in electronic device 100 chip version request signal+add value), logical operation, key value”. Encrypting the data included in the electronic device 100 chip version request signal means the same as encrypting the electronic device 100 chip version request signal. Here, the add value and the key value are random numbers generated by the electronic device 100.

The electronic device 100 receiving the encrypted electronic device 100 chip version request signal decrypts the encrypted electronic device 100 chip version request signal. The electronic device 100 calculates the data included in the electronic device 100 chip version request signal by performing a logical operation on the data and the key value included in the encrypted electronic device 100 chip version request signal and subtracting the add value from the result. That is, the electronic device 100 obtains the data included in the electronic device 100 chip version request signal through an operation of “(data included in the electronic device 100 chip version request signal, logical operation, key value)−add value”.

In an embodiment, at the electronic device 100 chip version response signal transmission step (step S540), the electronic device 100 performs encryption by performing a logical operation, using the key value included in the electronic device 100 chip version request signal, on a result of adding the data included in the electronic device 100 chip version response signal and the add value included in the electronic device 100 chip version request signal, and transmits the encrypted electronic device 100 chip version response signal.

The electronic device 100 encrypts the electronic device 100 chip version response signal in an encryption method described above and transmits the encrypted electronic device 100 chip version response signal to the electronic device authentication manager apparatus 110. That is, the electronic device 100 encrypts the data included in the electronic device 100 chip version response signal through an operation of “(data included in electronic device 100 chip version response signal+add value), logical operation, key value”. Encrypting the data included in the electronic device 100 chip version response signal means the same as encrypting the electronic device 100 chip version response signal. Here, the add value and the key value are random numbers generated by the electronic device 100.

The electronic device authentication manager apparatus 110 receiving the encrypted electronic device 100 chip version response signal decrypts the encrypted electronic device 100 chip version response signal. The electronic device authentication manager apparatus 110 calculates the data included in the electronic device 100 chip version response signal by performing a logical operation on the data and the key value included in the encrypted electronic device 100 chip version response signal and subtracting the add value. That is, the electronic device authentication manager apparatus 110 obtains the data included in the electronic device 100 chip version response signal through an operation of “(data included in the electronic device 100 chip version response signal, logical operation, key value)−add value”. Since the electronic device authentication manager apparatus 110 receives the add value and the key value included in the electronic device 100 chip version response signal transmitted from the electronic device 100, it can perform decryption through the add value and the key value.

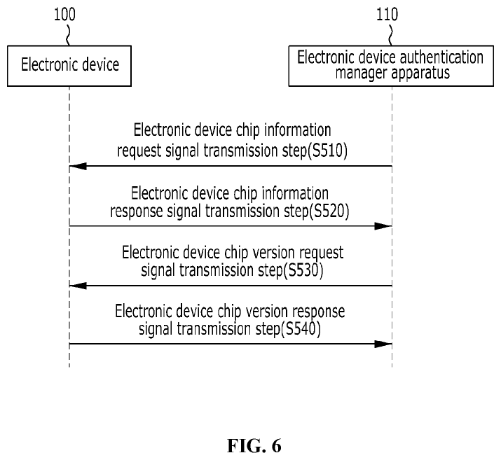

FIG. 6 is a sequence chart illustrating the operation process of an electronic device 100 chip information reception step (step S410) between an electronic device 100 and an electronic device authentication manager apparatus 110.

In an embodiment, at the electronic device 100 chip information request signal transmission step (step S510), the electronic device authentication manager apparatus 110 transmits an electronic device 100 chip information request signal to the electronic device 100. The electronic device 100 chip information request signal includes a message type, a check ID and other information.

The message type is a value set in the first byte of all request signals or response signals, which is a value identifying a type of an electronic device 100 chip information request signal. Here, the message type is a type of a signal. That is, the message type is a value set in the first byte of the electronic device 100 chip information request signal, and a type of the signal is distinguished according to the value. For example, the message type of the electronic device 100 chip information request signal is qwE0. The electronic device 100 receiving a signal, the first byte of which is set to qwE0, may recognize the signal as an electronic device 100 chip information request signal.

The check ID is an ID calculated by applying a hash function to a result of a logical operation performed on a value adding the current time to the name of the electronic device authentication manager apparatus 110 and a salt value. That is, the electronic device authentication manager apparatus 110 calculates the check ID through Hash (salt|name of device authentication manager apparatus 110, current time).

The other information includes the name of the electronic device authentication manager apparatus 110 and the current time.

In an embodiment, at the electronic device 100 chip information response signal transmission step (step S520), the electronic device 100 transmits an electronic device 100 chip information response signal to the electronic device authentication manager apparatus 110. The electronic device 100 chip information response signal includes a message type, a check ID and other information.

The message type is a value set in the first byte of all request signals or response signals, which is a value identifying a type of an electronic device 100 chip information response signal. Here, the message type is a type of a signal. That is, the message type is a value set in the first byte of the electronic device 100 chip information response signal, and a type of the signal is distinguished according to the value. For example, the message type of the electronic device 100 chip information response signal is qwE0. The electronic device authentication manager apparatus 110 receiving a signal, the first byte of which is set to qwE0, may recognize the signal as an electronic device 100 chip information response signal.

The check ID is an ID calculated by applying a hash function to a result of a logical operation performed on a salt value, a serial number, an add value and a key value. That is, the electronic device 100 calculates the check ID through Hash (salt value|serial number|add value|key value). Here, the add value and the key value are random numbers generated by the electronic device 100.

The other information includes a serial number, an add value and a key value.

In an embodiment, at the electronic device 100 chip version request signal transmission step (step S530), the electronic device authentication manager apparatus 110 transmits an electronic device 100 chip version request signal to the electronic device 100.

The message type is a value set in the first byte of all request signals or response signals, which is a value identifying a type of an electronic device 100 chip version request signal. Here, the message type is a type of a signal. That is, the message type is a value set in the first byte of the electronic device 100 chip version request signal, and a type of the signal is distinguished according to the value. For example, the message type of the electronic device 100 chip version request signal is qwE1. The electronic device 100 receiving a signal, the first byte of which is set to qwE1, may recognize the signal as an electronic device 100 chip version request signal.

The check ID is an ID calculated by applying a hash function to a result of a logical operation performed on a salt value, the name of the electronic device authentication manager apparatus 110, a version, and the current time. That is, the electronic device authentication manager apparatus 110 calculates the check ID through Hash (salt value|name of device authentication manager apparatus 110|version|current time). The version is the version of the electronic device 100 authentication method. For example, the current version is 1.0.

The other information includes the name, the version and the current time of the electronic device authentication manager apparatus 110.

In an embodiment, at the electronic device 100 chip version response signal transmission step (step S540), the electronic device 100 transmits an electronic device 100 chip version response signal to the electronic device authentication manager apparatus 110. The electronic device 100 chip version response signal includes a message type, a check ID and other information.

The message type is a value set in the first byte of all request signals or response signals, which is a value identifying a type of an electronic device 100 chip version response signal. Here, the message type is a type of a signal. That is, the message type is a value set in the first byte of the electronic device 100 chip version response signal, and a type of the signal is distinguished according to the value. For example, the message type of the electronic device 100 version response signal is qwE1. The electronic device authentication manager apparatus 110 receiving a signal, the first byte of which is set to qwE1, may recognize the signal as an electronic device 100 chip version response signal.

The check ID is an ID calculated by applying a hash function to a result of a logical operation performed on a salt value, a serial number, and a version. That is, the electronic device 100 calculates the check ID through Hash (salt value|serial number|version). Here, the version is the same as the version included in the electronic device 100 chip version request signal at the electronic device 100 chip version request signal transmission step. The salt value may be freely set to a value that is set by the electronic device 100 or the electronic device authentication manager apparatus.

The other information includes a serial number and a version.

In an embodiment, at the electronic device 100 chip information request signal transmission step (step S510), the electronic device authentication manager apparatus 110 performs encryption by performing a logical operation, using a key value of a default value, on a result of adding the data included in the electronic device 100 chip information request signal and an add value of a default value, and transmits the encrypted electronic device 100 chip information request signal.

The electronic device authentication manager apparatus 110 encrypts the electronic device 100 chip information request signal in an encryption method described above and transmits the encrypted electronic device 100 chip information request signal to the electronic device 100. That is, the electronic device authentication manager apparatus 110 encrypts the data included in the electronic device 100 chip information request signal through an operation of “(data included in electronic device 100 chip information request signal+add value), logical operation, key value”. Encrypting the data included in the electronic device 100 chip information request signal means the same as encrypting the electronic device 100 chip information request signal. Here, the add value and the key value are default values. For example, the default value of the add value is qw1234, and the default value of the key value is qw7445.

The electronic device 100 receiving the encrypted electronic device 100 chip information request signal decrypts the encrypted electronic device 100 chip information request signal. The electronic device 100 calculates the data included in the electronic device 100 chip information request signal by performing a logical operation on the data and the key value included in the encrypted electronic device 100 chip information request signal and subtracting the add value. That is, the electronic device 100 obtains the data included in the electronic device 100 chip information request signal through an operation of “(data included in the electronic device 100 chip information request signal, logical operation, key value)−add value”.

In an embodiment, at the electronic device 100 chip information response signal transmission step (step S520), the electronic device 100 performs encryption by performing a logical operation, using a key value of a default value, on a result of adding the data included in the electronic device 100 chip information response signal and the add value of a default value and transmits the encrypted electronic device 100 chip information response signal.

The electronic device 100 encrypts the electronic device 100 chip information response signal in an encryption method described above and transmits the encrypted electronic device 100 chip information response signal to the electronic device authentication manager apparatus 110. That is, the electronic device 100 encrypts the data included in the electronic device 100 chip information response signal through an operation of “(data included in electronic device 100 chip information response signal+add value), logical operation, key value”. Encrypting the data included in the electronic device 100 chip information response signal means the same as encrypting the electronic device 100 chip information response signal. Here, the add value and the key value are random numbers generated by the electronic device 100.

The electronic device authentication manager apparatus 110 receiving the encrypted electronic device 100 chip information response signal decrypts the encrypted electronic device 100 chip information response signal. The electronic device authentication manager apparatus 110 calculates the data included in the electronic device 100 chip information response signal by performing a logical operation on the data and the key value included in the encrypted electronic device 100 chip information response signal and subtracting the add value. That is, the electronic device authentication manager apparatus 110 obtains the data included in the electronic device 100 chip information response signal through an operation of “(data included in the electronic device 100 chip information response signal, logical operation, key value)−add value”. Since the electronic device authentication manager apparatus 110 receives the add value and the key value included in the electronic device 100 chip information response signal transmitted from the electronic device 100, it can perform decryption through the add value and the key value.

In an embodiment, at the electronic device 100 chip version request signal transmission step (step S530), the electronic device authentication manager apparatus 110 performs encryption by performing a logical operation, using the key value included in the electronic device 100 chip information response signal, on a result of adding the data included in the electronic device 100 chip version request signal and the add value included in the electronic device 100 chip information response signal, and transmits the encrypted electronic device 100 chip version request signal.

The electronic device authentication manager apparatus 110 encrypts the electronic device 100 chip version request signal in an encryption method described above and transmits the encrypted electronic device 100 chip version request signal to the electronic device 100. That is, the electronic device authentication manager apparatus 110 encrypts the data included in the electronic device 100 chip version request signal through an operation of “(data included in electronic device 100 chip version request signal+add value), logical operation, key value”. Encrypting the data included in the electronic device 100 chip version request signal means the same as encrypting the electronic device 100 chip version request signal. Here, the add value and the key value are random numbers generated by the electronic device 100.

The electronic device 100 receiving the encrypted electronic device 100 chip version request signal decrypts the encrypted electronic device 100 chip version request signal. The electronic device 100 calculates the data included in the electronic device 100 chip version request signal by performing a logical operation on the data and the key value included in the encrypted electronic device 100 chip version request signal and subtracting the add value from the result. That is, the electronic device 100 obtains the data included in the electronic device 100 chip version request signal through an operation of “(data included in the electronic device 100 chip version request signal, logical operation, key value)−add value”.

In an embodiment, at the electronic device 100 chip version response signal transmission step (step S540), the electronic device 100 performs encryption by performing a logical operation, using the key value included in the electronic device 100 chip version request signal, on a result of adding the data included in the electronic device 100 chip version response signal and the add value included in the electronic device 100 chip version request signal, and transmits the encrypted electronic device 100 chip version response signal.

The electronic device 100 encrypts the electronic device 100 chip version response signal in an encryption method described above and transmits the encrypted electronic device 100 chip version response signal to the electronic device authentication manager apparatus 110. That is, the electronic device 100 encrypts the data included in the electronic device 100 chip version response signal through an operation of “(data included in electronic device 100 chip version response signal+add value), logical operation, key value”. Encrypting the data included in the electronic device 100 chip version response signal means the same as encrypting the electronic device 100 chip version response signal. Here, the add value and the key value are random numbers generated by the electronic device 100.

The electronic device authentication manager apparatus 110 receiving the encrypted electronic device 100 chip version response signal decrypts the encrypted electronic device 100 chip version response signal. The electronic device authentication manager apparatus 110 calculates the data included in the electronic device 100 chip version response signal by performing a logical operation on the data and the key value included in the encrypted electronic device 100 chip version response signal and subtracting the add value. That is, the electronic device authentication manager apparatus 110 obtains the data included in the electronic device 100 chip version response signal through an operation of “(data included in the electronic device 100 chip version response signal, logical operation, key value)−add value”. Since the electronic device authentication manager apparatus 110 receives the add value and the key value included in the electronic device 100 chip version response signal transmitted from the electronic device 100, it can perform decryption through the add value and the key value.

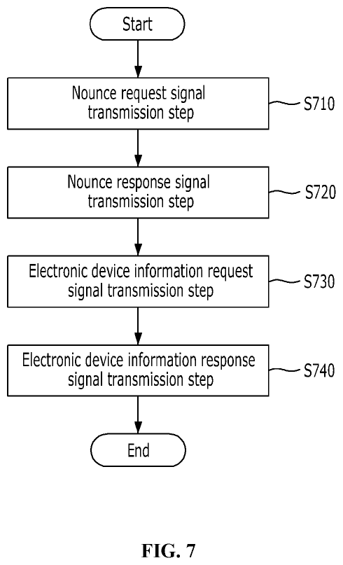

FIG. 7 is a flowchart illustrating the specific flow of a short distance wireless communication access step (step S420) according to an embodiment.

In an aspect, the short distance wireless communication access step (step S420) includes a nounce request signal transmission step (step S710), a nounce response signal transmission step (step S720), an electronic device 100 information request signal transmission step (step S730), and an electronic device 100 information response signal transmission step (step S740).

In an embodiment, at the nounce request signal transmission step (step S710), the electronic device authentication manager apparatus 110 transmits a nounce request signal to the electronic device 100. The nounce request signal includes a message type, a message length, a client type and a version.

The message type is a value set in the first byte of all request signals or response signals, which is a value identifying a type of a nounce request signal. Here, the message type is a type of a signal. That is, the message type is a value set in the first byte of the nounce request signal, and a type of the signal is distinguished according to the value. For example, the message type of the nounce request signal is qwa1. The electronic device 100 receiving a signal, the first byte of which is set to qwa1, may recognize the signal as a nounce request signal.

The message length is a message size subtracting the message type and the message length from the total message size. Here, the size is a length. It has been described above that the nounce request signal includes various kinds of other information, in addition to the message type and the message length. Here, the message length is a size subtracting a size corresponding to the message type and a size corresponding to the message length from the size, i.e., the length, of all the information that the nounce request signal includes. If the size of the message type is one byte, the size of the message length itself is four bytes, and the size of the total message is 85 bytes, the message length is 80 bytes. Here, the size of the total message is the size of the nounce request signal.

The client type is information on the type of a client. For example, a gateway or an electronic device authentication manager apparatus 110 is a type of a client. If the client is a gateway, the client type is qw00000001. If the client is an electronic device authentication manager apparatus 110, the client type is qw00000002.

In an embodiment, at the nounce response signal transmission step (step S720), the electronic device 100 creates a nounce response signal and transmits the nounce response signal to the electronic device authentication manager apparatus 110. The nounce response signal includes a message type, a message length, a result code and a nounce.

The message type is a value set in the first byte of all request signals or response signals, which is a value identifying a type of a nounce response signal. Here, the message type is a type of a signal. That is, the message type is a value set in the first byte of the nounce response signal, and a type of the signal is distinguished according to the value. For example, the message type of the nounce response signal is qwc1. The electronic device 100 receiving a signal, the first byte of which is set to qwc1, may recognize the signal as a nounce response signal.

The message length is a message size subtracting the message type and the message length from the total message size. Here, the size is a length. It has been described above that the nounce response signal includes various kinds of other information, in addition to the message type and the message length. Here, the message length is a size subtracting a size corresponding to the message type and a size corresponding to the message length from the size, i.e., the length, of all the information that the nounce response signal includes. If the size of the message type is one byte, the size of the message length itself is four bytes, and the size of the total message is 85 bytes, the message length is 80 bytes. Here, the size of the total message is the size of the nounce response signal.

The result code is a code indicating whether the nounce response signal is transferred to the electronic device 100 without an error. For example, if the result code is 0, it means that the nounce response signal is transferred to the electronic device 100 without an error.

The nounce is a random number created by the electronic device 100 or a current time.

In an embodiment, at the electronic device 100 information request signal transmission step (step S730), the electronic device authentication manager apparatus 110 transmits an electronic device 100 information request signal to the electronic device 100. The electronic device 100 information request signal includes a message type, a message length, electronic device 100 information request command information, a hash-processed electronic device 100 password, and a session ID.

The message type is a value set in the first byte of all request signals or response signals, which is a value identifying a type of an electronic device 100 information request signal. Here, the message type is a type of a signal. That is, the message type is a value set in the first byte of the electronic device 100 information request signal, and a type of the signal is distinguished according to the value. For example, the message type of the electronic device 100 information request signal is qw05. The electronic device 100 receiving a signal, the first byte of which is set to qw05, may recognize the signal as an electronic device 100 information request signal.

The message length is a message size subtracting the message type and the message length from the total message size. Here, the size is a length. It has been described above that the electronic device 100 information request signal includes various kinds of other information, in addition to the message type and the message length. Here, the message length is a size subtracting a size corresponding to the message type and a size corresponding to the message length from the size, i.e., the length, of all the information that the electronic device 100 information request signal includes. If the size of the message type is one byte, the size of the message length itself is four bytes, and the size of the total message is 85 bytes, the message length is 80 bytes. Here, the size of the total message is the size of the electronic device 100 information request signal.

The electronic device 100 information request command information is information calculated by applying a hash to a result of a logical operation performed on the client type information and the nounce by the electronic device authentication manager apparatus 110. That is, the electronic device authentication manager apparatus 110 calculates the electronic device 100 information request command information through an operation of Hash (client type|nounce).

The hash-processed electronic device 100 password is a hash-processed value of the electronic device 100 password. That is, the hash-processed electronic device 100 password is a result of Hash (electronic device 100 password) calculation performed by the electronic device authentication manager apparatus 110.

The session ID is an ID calculated by the electronic device authentication manager apparatus 110 by applying a hash function to a result of a logical operation performed on a transaction ID, a serial number, a client type and a nounce. Here, the nounce is the time at the time point of creating the session ID or a random number arbitrarily generated by the electronic device authentication manager apparatus 110.

In an embodiment, at the electronic device 100 information response signal transmission step (step S740), the electronic device 100 creates an electronic device 100 information response signal and transmits the electronic device 100 information response signal to the electronic device authentication manager apparatus 110. The electronic device 100 information response signal includes a message type, a message length, a result code, a unique ID and a serial number.

The message type is a value set in the first byte of the electronic device 100 information response signal, which is a value identifying a type of an electronic device 100 information response signal. Here, the message type is a type of a signal. That is, the message type is a value set in the first byte of the electronic device 100 information response signal, and a type of the signal is distinguished according to the value. For example, the message type of the electronic device 100 information response signal is qw8. The electronic device 100 receiving a signal, the first byte of which is set to qw8, may recognize the signal as an electronic device 100 information response signal.

The message length is a message size subtracting the message type and the message length from the total message size. Here, the size is a length. It has been described above that the electronic device 100 information response signal includes various kinds of other information, in addition to the message type and the message length. Here, the message length is a size subtracting a size corresponding to the message type and a size corresponding to the message length from the size, i.e., the length, of all the information that the electronic device 100 information response signal includes. If the size of the message type is one byte, the size of the message length itself is four bytes, and the size of the total message is 85 bytes, the message length is 80 bytes. Here, the size of the total message is the size of the electronic device 100 information response signal.

The result code becomes a different value according to whether the electronic device 100 information request command information included in the electronic device 100 information request signal matches the electronic device 100 information request command information created by the electronic device 100. If the electronic device 100 information request command information matches, the result code is calculated as, for example, 0. If the electronic device 100 information request command information does not match, the result code is calculated as, for example, 106. Security is strengthened since the electronic device authentication manager apparatus 110 and the electronic device 100 respectively go through an authentication process by comparing a result calculated by applying a hash to a result of a logical operation performed on the client type information and the nounce information.

The serial number is a unique number of the electronic device 100. Every electronic device 100 capable of performing short distance wireless communication or wired communication with the electronic device authentication manager apparatus 110 includes a unique number.

The unique ID is an ID of a chip installed in the electronic device 100. The unique ID is information created by the electronic device 100. The unique ID is a result of applying a hash to a result of applying a salt to the serial number of the electronic device 100, in which a chip is installed. It has been described above that every electronic device 100 has a serial number, which is a unique number. The salt is a value set by a user, which is a value not to expose a relationship between the serial number and the unique ID. Applying a salt is performing a logical operation using a serial number and a value specified by a user, for example, a salt value ‘1234’ and a serial number. A result of applying a hash function to a result of performing a logical operation on the salt value and the serial number is the unique ID.

In an embodiment, the nounce response signal includes nounce information, and the nounce information is the current time or a random number created by the electronic device 100. The current time is the time at the time point of creating the nounce response signal.

In an embodiment, the electronic device 100 information request signal includes the electronic device 100 information request command information calculated by the electronic device authentication manager apparatus 110 through an input including a nounce and a hash function. The input including a nounce is client type information and nounce information. Being calculated through an input and a hash function is using the input described above as the domain definition of the hash function. Since there are two inputs in this embodiment, it is applying a hash function to a result of a logical operation performed on the client type information and the nounce information, which are the inputs.

In an embodiment, at the electronic device 100 information response signal transmission step (step S740), the electronic device 100 compares the electronic device 100 information request command information included in the received electronic device 100 information request signal and the electronic device 100 information request command information created by the electronic device 100, puts information on whether the information matches into the electronic device 100 information response signal, and transmits the electronic device 100 information response signal to the electronic device authentication manager apparatus 110. Information on whether the information matches is the result code described above.

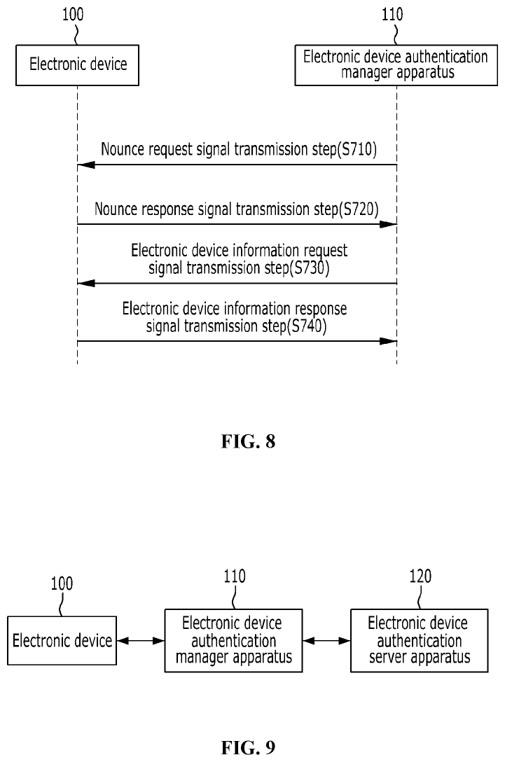

FIG. 8 is a sequence chart illustrating the operation process of a short distance wireless communication access step (step S420) between an electronic device 100 and an electronic device authentication manager apparatus 110.

In an embodiment, at the nounce request signal transmission step (step S710), the electronic device authentication manager apparatus 110 transmits a nounce request signal to the electronic device 100. The nounce request signal includes a message type, a message length, a client type and a version.

The message type is a value set in the first byte of all request signals or response signals, which is a value identifying a type of a nounce request signal. Here, the message type is a type of a signal. That is, the message type is a value set in the first byte of the nounce request signal, and a type of the signal is distinguished according to the value. For example, the message type of the nounce request signal is qwa1. The electronic device 100 receiving a signal, the first byte of which is set to qwa1, may recognize the signal as a nounce request signal.

The message length is a message size subtracting the message type and the message length from the total message size. Here, the size is a length. It has been described above that the nounce request signal includes various kinds of other information, in addition to the message type and the message length. Here, the message length is a size subtracting a size corresponding to the message type and a size corresponding to the message length from the size, i.e., the length, of all the information that the nounce request signal includes. If the size of the message type is one byte, the size of the message length itself is four bytes, and the size of the total message is 85 bytes, the message length is 80 bytes. Here, the size of the total message is the size of the nounce request signal.

The client type is information on the type of a client. For example, a gateway or an electronic device authentication manager apparatus 110 is a type of a client. If the client is a gateway, the client type is qw00000001. If the client is an electronic device authentication manager apparatus 110, the client type is qw00000002.

In an embodiment, at the nounce response signal transmission step (step S720), the electronic device 100 creates a nounce response signal and transmits the nounce response signal to the electronic device authentication manager apparatus 110. The nounce response signal includes a message type, a message length, a result code and a nounce.

The message type is a value set in the first byte of all request signals or response signals, which is a value identifying a type of a nounce response signal. Here, the message type is a type of a signal. That is, the message type is a value set in the first byte of the nounce response signal, and a type of the signal is distinguished according to the value. For example, the message type of the nounce response signal is qwc1. The electronic device 100 receiving a signal, the first byte of which is set to qwc1, may recognize the signal as a nounce response signal.

The message length is a message size subtracting the message type and the message length from the total message size. Here, the size is a length. It has been described above that the nounce response signal includes various kinds of other information, in addition to the message type and the message length. Here, the message length is a size subtracting a size corresponding to the message type and a size corresponding to the message length from the size, i.e., the length, of all the information that the nounce response signal includes. If the size of the message type is one byte, the size of the message length itself is four bytes, and the size of the total message is 85 bytes, the message length is 80 bytes. Here, the size of the total message is the size of the nounce response signal.

The result code is a code indicating whether the nounce response signal is transferred to the electronic device 100 without an error. For example, if the result code is 0, it means that the nounce response signal is transferred to the electronic device 100 without an error.

The nounce is a random number created by the electronic device 100 or a current time.

In an embodiment, at the electronic device 100 information request signal transmission step (step S730), the electronic device authentication manager apparatus 110 transmits an electronic device 100 information request signal to the electronic device 100. The electronic device 100 information request signal includes a message type, a message length, electronic device 100 information request command information, a hash-processed electronic device 100 password, and a session ID.

The message type is a value set in the first byte of all request signals or response signals, which is a value identifying a type of an electronic device 100 information request signal. Here, the message type is a type of a signal. That is, the message type is a value set in the first byte of the electronic device 100 information request signal, and a type of the signal is distinguished according to the value. For example, the message type of the electronic device 100 information request signal is qw05. The electronic device 100 receiving a signal, the first byte of which is set to qw05, may recognize the signal as an electronic device 100 information request signal.

The message length is a message size subtracting the message type and the message length from the total message size. Here, the size is a length. It has been described above that the electronic device 100 information request signal includes various kinds of other information, in addition to the message type and the message length. Here, the message length is a size subtracting a size corresponding to the message type and a size corresponding to the message length from the size, i.e., the length, of all the information that the electronic device 100 information request signal includes. If the size of the message type is one byte, the size of the message length itself is four bytes, and the size of the total message is 85 bytes, the message length is 80 bytes. Here, the size of the total message is the size of the electronic device 100 information request signal.

The electronic device 100 information request command information is information calculated by applying a hash to a result of a logical operation performed on the client type information and the nounce by the electronic device authentication manager apparatus 110. That is, the electronic device authentication manager apparatus 110 calculates the electronic device 100 information request command information through an operation of Hash (client type|nounce).

The hash-processed electronic device 100 password is a hash-processed value of the electronic device 100 password. That is, the hash-processed electronic device 100 password is a result of Hash (electronic device 100 password) calculation performed by the electronic device authentication manager apparatus 110.

The session ID is an ID calculated by the electronic device authentication manager apparatus 110 by applying a hash function to a result of a logical operation performed on a transaction ID, a serial number, a client type and a nounce. Here, the nounce is the time at the time point of creating the session ID or a random number arbitrarily generated by the electronic device authentication manager apparatus 110.

In an embodiment, at the electronic device 100 information response signal transmission step (step S740), the electronic device 100 creates an electronic device 100 information response signal and transmits the electronic device 100 information response signal to the electronic device authentication manager apparatus 110. The electronic device 100 information response signal includes a message type, a message length, a result code, a unique ID and a serial number.

The message type is a value set in the first byte of the electronic device 100 information response signal, which is a value identifying a type of an electronic device 100 information response signal. Here, the message type is a type of a signal. That is, the message type is a value set in the first byte of the electronic device 100 information response signal, and a type of the signal is distinguished according to the value. For example, the message type of the electronic device 100 information response signal is qw8. The electronic device 100 receiving a signal, the first byte of which is set to qw8, may recognize the signal as an electronic device 100 information response signal.

The message length is a message size subtracting the message type and the message length from the total message size. Here, the size is a length. It has been described above that the electronic device 100 information response signal includes various kinds of other information, in addition to the message type and the message length. Here, the message length is a size subtracting a size corresponding to the message type and a size corresponding to the message length from the size, i.e., the length, of all the information that the electronic device 100 information response signal includes. If the size of the message type is one byte, the size of the message length itself is four bytes, and the size of the total message is 85 bytes, the message length is 80 bytes. Here, the size of the total message is the size of the electronic device 100 information response signal.

The result code becomes a different value according to whether the electronic device 100 information request command information included in the electronic device 100 information request signal matches the electronic device 100 information request command information created by the electronic device 100. If the electronic device 100 information request command information matches, the result code is calculated as, for example, 0. If the electronic device 100 information request command information does not match, the result code is calculated as, for example, 106. Security is strengthened since the electronic device authentication manager apparatus 110 and the electronic device 100 respectively go through an authentication process by comparing a result calculated by applying a hash to a result of a logical operation performed on the client type information and the nounce information.

The serial number is a unique number of the electronic device 100. Every electronic device 100 capable of performing short distance wireless communication or wired communication with the electronic device authentication manager apparatus 110 includes a unique number.

The unique ID is an ID of a chip installed in the electronic device 100. The unique ID is information created by the electronic device 100. The unique ID is a result of applying a hash to a result of applying a salt to the serial number of the electronic device 100, in which a chip is installed. It has been described above that every electronic device 100 has a serial number, which is a unique number. The salt is a value set by a user, which is a value not to expose a relationship between the serial number and the unique ID. Applying a salt is performing a logical operation using a serial number and a value specified by a user, for example, a salt value ‘1234’ and a serial number. A result of applying a hash function to a result of performing a logical operation on the salt value and the serial number is the unique ID.

In an embodiment, the nounce response signal includes nounce information, and the nounce information is the current time or a random number created by the electronic device 100. The current time is the time at the time point of creating the nounce response signal.

In an embodiment, the electronic device 100 information request signal includes the electronic device 100 information request command information calculated by the electronic device authentication manager apparatus 110 through an input including a nounce and a hash function. The input including a nounce is client type information and nounce information. Being calculated through an input and a hash function is using the input described above as the domain definition of the hash function. Since there are two inputs in this embodiment, it is applying a hash function to a result of a logical operation performed on the client type information and the nounce information, which are the inputs.

In an embodiment, at the electronic device 100 information response signal transmission step (step S740), the electronic device 100 compares the electronic device 100 information request command information included in the received electronic device 100 information request signal and the electronic device 100 information request command information created by the electronic device 100, puts information on whether the information matches in the electronic device 100 information response signal, and transmits the electronic device 100 information response signal to the electronic device authentication manager apparatus 110. Information on whether the information matches is the result code described above.

FIG. 9 is a view showing the configuration of an electronic device authentication system.

In an aspect, an electronic device authentication system includes an electronic device authentication server apparatus and an electronic device authentication manager apparatus.

In an embodiment, the electronic device authentication server apparatus decrypts an encrypted authentication code request signal, creates an authentication code according to the authentication code request signal, creates a signed authentication code by signing the created authentication code, and encrypts the signed authentication code.

The electronic device authentication server apparatus is a device which creates an authentication code for authenticating an electronic device. The electronic device authentication manager apparatus transmits the encrypted authentication code request signal, and the encrypted authentication code request signal has been described above in detail. The electronic device authentication server apparatus creates a signed authentication code by signing the authentication code, and the signed authentication code has been described above in detail. The electronic device authentication server apparatus encrypts the signed authentication code and transmits the encrypted and signed authentication code to the electronic device authentication manager apparatus.

In an embodiment, the electronic device authentication manager apparatus encrypts the authentication code request signal and transmits the encrypted authentication code request signal to the electronic device authentication server apparatus, and receives the encrypted and signed authentication code from the electronic device authentication server apparatus, and decrypts the encrypted and signed authentication code.

The electronic device authentication manager apparatus relays the process of receiving an authentication code for authenticating the electronic device issued by an electronic device authentication server apparatus. That is, the electronic device authentication manager apparatus receives an authentication code from the electronic device authentication server apparatus and transmits the authentication code to the electronic device. The electronic device authentication manager apparatus connects to the electronic device through a GPIO interface so that the electronic device may receive and store the signed authentication code.

The electronic device authentication manager apparatus encrypts the authentication code request signal and transmits the encrypted authentication code request signal to the electronic device authentication server apparatus, and the encrypted authentication code request signal has been described above in detail. The electronic device authentication manager apparatus receives and decrypts the encrypted and signed authentication code, and this has been described above in detail at the encrypted and signed authentication code decryption step.

The electronic device authentication system may further include an electronic device.

In an embodiment, the electronic device receives a signed authentication code from the electronic device authentication manager apparatus and transmits an authentication code storage response signal to the electronic device authentication manager apparatus. The process of receiving a signed authentication code by the electronic device has been described at the authentication code storage request signal transmission step. The process of transmitting the authentication code storage response signal by the electronic device to the electronic device authentication manager apparatus has been described at the authentication code storage response signal transmission step.

In an embodiment, the authentication code includes at least one among a serial number, a unique ID, a random number, a transaction ID, an effective time, an effective number of times, an access control policy, and an encryption algorithm. Each piece of information included in the authentication code has been described above in detail.

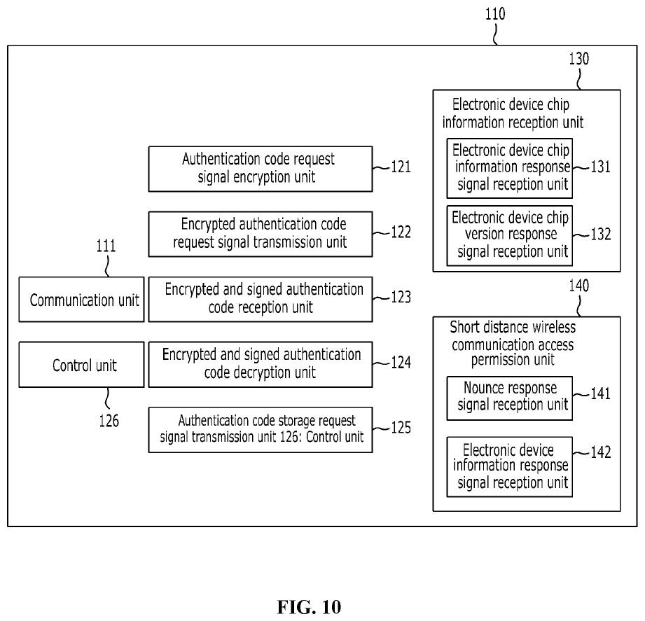

FIG. 10 is a view showing the configuration of an electronic device authentication manager apparatus.

In an embodiment, an electronic device authentication manager apparatus includes a communication unit 111, a control unit 126, an authentication code request signal encryption unit 121, an encrypted authentication code request signal transmission unit 122, an encrypted and signed authentication code reception unit 123, an encrypted and signed authentication code decryption unit 124, and an authentication code storage request signal transmission unit 125.

The communication unit 111 communicates in a communication method including at least one among ZigBee, Wi-Fi, Bluetooth and near field communication (NFC).

The electronic device authentication manager apparatus is connected to the electronic device through a GPIO interface.

The control unit 126 generally controls the electronic device authentication manager apparatus 110. The control unit 126 is a microcontroller or a microprocessor. The authentication code request signal encryption unit 121, the encrypted authentication code request signal transmission unit 122, the encrypted and signed authentication code reception unit 123, the encrypted and signed authentication code decryption unit 124, the authentication code storage request signal transmission unit 125, an electronic device chip information reception unit 130, a short distance wireless communication access permission unit 140, an electronic device chip information response signal reception unit 131, an electronic device chip version response signal reception unit 132, a nounce response signal reception unit 141, and an electronic device information response signal reception unit 142 are implemented as program command sets executed by the control unit. However, they are not limited thereto and may be implemented by dedicated hardware, for example, a sequence and/or combination logic circuit.

In an embodiment, the authentication code request signal encryption unit 121 encrypts an authentication code request signal, and this has been described at the authentication code request signal encryption step.

In an embodiment, the encrypted authentication code request signal transmission unit 122 transmits an encrypted authentication code request signal through the communication unit 111, and this has been described above in detail at the encrypted authentication code request signal transmission step.

In addition, the encrypted authentication code request signal transmission unit may transmit the encrypted authentication code request signal to the electronic device. The electronic device may transmit the encrypted authentication code request signal to the electronic device authentication server apparatus.

In an embodiment, the encrypted and signed authentication code reception unit 123 receives an encrypted and signed authentication code from the electronic device authentication server apparatus through the communication unit 111, and this has been described above in detail at the encrypted and signed authentication code reception step.

The encrypted and signed authentication code reception unit 123 may receive an encrypted and signed authentication code from the electronic device. That is, the electronic device may receive the encrypted and signed authentication code from the electronic device authentication server apparatus and transmit the encrypted and signed authentication code to the electronic device authentication manager apparatus.

In an embodiment, the encrypted and signed authentication code decryption unit 124 decrypts the encrypted and signed authentication code, and this has been described above in detail at the encrypted and signed authentication code decryption step.

In an embodiment, the authentication code storage request signal transmission unit 125 transmits an authentication code storage request signal to the electronic device, and this has been described above in detail at the authentication code storage request signal transmission step.

In an embodiment, the electronic device authentication manager apparatus 110 includes the electronic device chip information reception unit 130 and the short distance wireless communication access permission unit 140.

In an embodiment, the electronic device chip information reception unit 130 receives information on a chip installed in an electronic device from the electronic device, and this has been described above in detail at the electronic device chip information reception step.

In an embodiment, the short distance wireless communication access permission unit 140 permits short distance wireless communication access of the electronic device, and this has been described above in detail at the short distance wireless communication access step.

In an embodiment, the electronic device chip information reception unit 130 includes an electronic device chip information response signal reception unit 131 and an electronic device chip version response signal reception unit 132.

In an embodiment, the electronic device chip information response signal reception unit 131 receives an electronic device chip information response signal from the electronic device, and this has been described above in detail at the electronic device chip information response signal reception step.

In an embodiment, the electronic device chip version response signal reception unit 132 receives an electronic device chip version response signal from the electronic device, and this has been described above in detail at the electronic device chip version response signal reception step.

In an embodiment, the short distance wireless communication access permission unit 140 includes a nounce response signal reception unit 141 and an electronic device information response signal reception unit 142.

In an embodiment, the nounce response signal reception unit 141 receives a nounce response signal from the electronic device, and this has been described above in detail at the nounce response signal transmission step.

In an embodiment, the electronic device information response signal reception unit 142 receives an electronic device information response signal from the electronic device, and this has been described above in detail at the electronic device information response signal transmission step.

As described above, those skilled in the art may recognize that the present invention can be embodied in other specific embodiments without changing the spirits or essential features thereof. Accordingly, it should be understood that the embodiments described above are only illustrative and not restrictive limiting the scope. In addition, the flowcharts shown in the drawings are only sequential orders shown for illustrative purposes to attain the most desirable result in embodying the present invention, and it is apparent that other additional steps can be provided or some of the steps can be deleted.

The technical features described in this specification and the implementations executing the same may be implemented as a digital electronic circuit, implemented as computer software, firmware or hardware including the structures described in this specification or the structural equivalents thereof, or implemented as a combination of one or more of these. In addition, the implementations executing the features described in this specification may be implemented as a computer program product, in other words, a module related to computer program commands encoded on a tangible program storage medium to control the operation of the system or for the execution by the system.

A computer-readable medium may be a machine-readable storage device, a machine-readable storage substrate, a memory device, a composition of materials having an effect on machine-readable propagation-type signals, or a combination of one or more of these.

Meanwhile, in this specification, an “apparatus” or a “system” includes, for example, a processor, a computer and all devices, apparatuses and machines for processing information, including a multiprocessor or the computer. A processing system may include, in addition to hardware, all codes which form an execution environment for a computer program when it is requested, for example, a code configuring processor firmware, a protocol stack, an information base management system, an operating system, and a combination of one or more of these.

A computer program known as a program, software, a software application, a script, a code or the like may be created in any form of a programming language including a compiled or interpreted language or a declarative or procedural language and may be implemented in any form including an independent program or module, a component, a subroutine, or other units suitable for being used in a computer environment.

Meanwhile, the computer program does not necessarily correspond to a file in a file system and may be stored in a single file provided in a requested program, in multiple interacting files (e.g., files storing one or more modules, subprograms or part of a code), or in a part of a file possessing other programs or information (e.g., one or more scripts stored in a markup language document).

The computer program may be implemented to be executed in multiple computers or one or more computers located in one site or distributed across a plurality of sites and interconnected through wired/wireless communication networks.

Meanwhile, a computer-readable medium suitable for storing computer program commands and information may include, for example, all forms of nonvolatile memory, media and memory devices, including semiconductor memory devices such as EPROM, EEPROM and a flash memory device, magnetic disks such as internal hard disks or external disks, magneto-optical disks, and CD or DVD disks. The processor and memory may be supplemented by or incorporated in a special-purpose logic circuit.

The implementations executing the technical features described in this specification may be implemented in a computing system including backend components such as an information server, middleware components such as an application server, frontend components such as a client component having a web browser or a web graphical user interface, with which a user may interact with the implementations of a subject described in this specification, or all combinations of one or more of the backend, middleware and frontend components. The components of the system may interact with each other by any form or medium of digital information communication such as a communication network.

Hereinafter, further specific embodiments which can implement the configurations included in the system and method described in this specification will be described in detail, together with the contents described above.

In this specification, the method may be used in part or as a whole on a client device, a server related to a web-based storage system, or one or more processors included in the server through a means which executes computer software, program codes or commands. Here, the processor may be any one of computing platforms such as a server, a client, a network infrastructure, a mobile computing platform, a fixed computing platform and the like, and specifically, it may be a kind of computer or processing device which can process program commands, codes and the like. In addition, the processor may further include a memory for storing methods, commands, codes and programs, and when the processor does not include a memory, it may access a storage device such as a CD-ROM, a DVD, a memory, a hard disk, a flash drive, RAM, ROM, a cache or the like, in which methods, commands, codes and programs according to the present invention are stored, through a separate interface.

In addition, the system and method described in this specification may be used in part or as a whole through a device executing computer software on a server, a client, a gateway, a hub, a router or network hardware. Here, the software may be executed in various kinds of servers such as a file server, a print server, a domain server, an Internet server, an Intranet server, a host server, a distributed server and the like, and the servers mentioned above may further include an interface capable of accessing a memory, a processor, a computer-readable storage medium, a storage medium, a communication device, a port, a client and other servers through wired/wireless networks.

In addition, the method, commands, codes and the like according to the present invention may also be executed by the server, and other devices needed to execute the method may be implemented as part of a hierarchical structure related to the server.

In addition, the server may provide an interface to other devices, unlimitedly including clients, other devices, printers, information base servers, print servers, file servers, communication servers, distributed servers and the like, and connections through the interface may facilitate remote execution of a program through wired/wireless networks.

In addition, any one of the devices connected to the server through the interface may further include at least a storage device which can store the methods, commands, codes and the like, and the central processor of the server may provide commands, codes and the like, which will be executed on different devices, to the devices to be stored in the storage device.

Meanwhile, in this specification, the method may be used in part or as a whole through a network infrastructure. Here, the network infrastructure may include all the devices such as a computing device, a server, a router, a hub, a firewall, a client, a personal computer, a communication device, a routing device and the like, in addition to separate modules which can execute their own functions. The network infrastructure may further include storage media such as a storage, a flash memory, a buffer, a stack, RAM, ROM and the like, in addition to the devices described above. In addition, the methods, commands, codes and the like may also be executed and stored by any one among the devices, modules and storage media included in the network infrastructure, and other devices needed to execute the methods may also be implemented as part of the network infrastructure.

In addition, the system and method described in this specification may be implemented as hardware or a combination of hardware and software suitable for a specific application. Here, the hardware includes all general-purpose computer devices such as a personal computer, a mobile communication terminal and the like and enterprise-specific computer devices, and the computer device may be implemented as a device including a memory, a microprocessor, a microcontroller, a digital signal processor, an application integrated circuit, a programmable gate array, a programmable array organization and the like or a combination of these.

The computer software, commands, codes and the like described above may be stored or accessed by a readable device, and here, the readable device may include memory such as a computer component provided with digital information used for computing during a predetermined time interval, a semiconductor storage such as RAM or ROM, a permanent storage such as an optical disk, a large capacity storage such as a hard disk, a tape, a drum or the like, an optical storage such as a CD or a DVD, a flash memory, a floppy disk, a magnetic tape, a paper tape, an independent RAM disk, a large capacity storage detachable from a computer, a dynamic memory, a static memory, a variable storage, a network attached storage such as a cloud, and the like. Meanwhile, here, although the commands, codes and the like include all of the information-oriented languages such as SQL, dBase and the like, system languages such as C, Objective C, C++, assembly and the like, architecture languages such as Java, .NET and the like, and application languages such as PHP, Ruby, Perl, Python and the like, it is not limited thereto, and all the languages known to those skilled in the art can be included.

In addition, the “computer-readable media” described in this specification include all media which contribute to providing commands to a processor for execution of a program. Specifically, although the media include nonvolatile media such as an information storage device, an optical device, a magnetic disk and the like, volatile media such as a dynamic memory and the like, and transmission media such as a coaxial cable, a copper wire, an optical fiber and the like for transmitting information, it is not limited thereto.

Meanwhile, the configurations executing technical features of the present invention included in the block diagrams and flowcharts shown in the accompanying drawings mean logical boundaries between the configurations.

However, according to the embodiments of software or hardware, since the configurations shown in the figures and functions thereof are executed in the form of an independent software module, a monolithic software structure, a code, a service or a combination thereof and the functions can be implemented as the configurations and functions are stored in a medium executable in a computer provided with a processor which can execute a stored program code, command or the like, all of these embodiments should also be regarded as being in the scope of the present invention.

Therefore, although the accompanying drawings and descriptions thereof describe technical features of the present invention, the features should not be simply inferred as far as specific arrangements of software for implementing the technical features are not clearly mentioned. That is, diverse embodiments as described above may exist, and since the embodiments may be partially modified while possessing technical features the same of those of the present invention, these embodiments should also be regarded as being in the scope of the present invention.

In addition, although the flowcharts illustrate the operations in the drawing in a specific order, these are shown in the drawings to get a most desirable result, and it should not be understood in a way that the operations should be executed in the illustrated specific order or all the operations shown in the drawings should be necessarily executed. In a specific case, multi-tasking and parallel processing may be advantageous. In addition, it should not be understood in a way that separation of diverse system components of the embodiments described above is not always requested in all embodiments, it should be understood that the described program components and systems can be generally integrated with each other as a single software product or packaged in a multi-software product.

As described above, this specification is not intended to limit the present invention by the presented specific terms. Accordingly, although the present invention has been described in detail with reference to the embodiments described above, those skilled in the art may make alterations, changes and modifications to the embodiments without departing from the scope of the present invention.

It should be interpreted such that the scope of the present invention is defined by the claims described below, rather than the detailed descriptions described above, and the meaning and scope of the claims and all the changed or modified forms derived from the equivalent concepts thereof are included in the scope of the present invention.

### INDUSTRIAL APPLICABILITY

The present invention relates to a technique of authenticating an electronic device, and more specifically, to a method of authenticating an electronic device using a simplified authentication code.

An object of the proposed present invention is to easily authenticate an electronic device of a low hardware performance specification using a simplified authentication code.

1. An electronic device authentication manager apparatus comprising:
a control unit for generally controlling the electronic device authentication manager apparatus;
an authentication code request signal encryption unit for encrypting an authentication code request signal;
an encrypted authentication code request signal transmission unit for transmitting an encrypted authentication code request signal to an electronic device;
an encrypted and signed authentication code reception unit for receiving an encrypted and signed authentication code from the electronic device;
an encrypted and signed authentication code decryption unit for decrypting the encrypted and signed authentication code; and
an authentication code storage request signal transmission unit for transmitting an authentication code storage request signal to the electronic device,
wherein the electronic device authentication manager apparatus is connected to the electronic device through a GPIO interface.

2. The apparatus according to claim 1, wherein the authentication code includes at least one among a serial number, a unique ID, a random number, a transaction ID, an effective time, an effective number of times, an access control policy, and an encryption algorithm.

3. The apparatus according to claim 1, further comprising:
an electronic device chip information reception unit for receiving information on a chip installed in the electronic device from the electronic device; and
a short distance wireless communication access permission unit for permitting short distance wireless communication access of the electronic device.

4. The apparatus according to claim 3, wherein the electronic device chip information reception unit includes:
an electronic device chip information response signal reception unit for receiving an electronic device chip information response signal from the electronic device; and
an electronic device chip version response signal reception unit for receiving an electronic device chip version response signal from the electronic device.

5. The apparatus according to claim 3, wherein the short distance wireless communication access permission unit includes:
a nounce response signal reception unit for receiving a nounce response signal from the electronic device; and
an electronic device information response signal reception unit for receiving an electronic device information response signal from the electronic device.
